(19) United States
(12) Patent Application Publication
(10) Pub. No.: US 2023/0256568 A1
(43) Pub. Date: Aug. 17, 2023

(54) TRANSMISSION GEAR FOR A SWING CLAMP

(71) Applicant: Ludwig Ehrhardt GmbH, Laubach (DE)

(72) Inventor: Hendrik KRATZ, Hungen (DE)

(21) Appl. No.: 18/010,651

(22) PCT Filed: Jun. 16, 2021
(86) PCT No.: PCT/EP2021/066171

§ 371 Date: Dec. 15, 2022

(30) Foreign Application Priority Data
Jun. 16, 2020 (DE) 10 2020 115 803.3

(51) Int. Cl. B25B 5/06; F16H 25/18

(52) U.S. Cl. CPC B25B 5/062; F16H 25/186

(57) ABSTRACT

The invention relates to a drive transmission for converting a drive movement into an output movement, in particular in a swing clamp (1) for clamping components. The drive transmission according to the invention first comprises a movable drive element (9), in particular in the form of a piston, which carries out the drive movement during operation. Additionally, the drive transmission according to the invention has a movable output element (4), in particular in the form of a rod, which carries out the output movement during operation, and a cam gear, which converts the drive movement of the drive element (9) into the output movement of the output element (4) according to a specified transmission curve, wherein of the drive movement and the output movement, one movement is or contains an axial movement along a specified movement axis while the other movement is or at least contains a rotational movement about the movement axis. According to the invention, the cam gear has two contact surfaces (F1, F2) which slide against each other in a planar manner and thereby convert the drive movement.

The invention relates to a transmission gear for converting movement from a driving movement to an output movement, in particular in a swing device (e.g. swing clamp for clamping components or hydraulic swing motor).

A conventional swing clamp is known from EP 1 264 659 B1 and DE 102 52 549 A1, which is used, for example, for clamping workpieces on machine tables. In this case, a clamping bar is pivotable and axially displaceable, the movement of the clamping bar being driven by a piston which is axially displaceable in a working cylinder of the swing clamp under pressure medium actuation. A transmission gear is arranged between the displaceable piston and the displaceable and swing clamp, which converts the purely axial movement of the piston into the combined swiveling and axial movement of the clamping bar. In the case of the known swing clamp, this movement conversion takes place with a slotted guide system. In addition, the known swing clamp has seals that prevent the penetration of media (e.g. hydraulic oil) in the axial direction along the link guide. These seals are arranged axially above and below the slotted guide system, which increases the axial overall height of the conventional swing clamp, since the seals require installation space above and below the slotted guide system. The disadvantage of the known swing clamp is therefore the fact that the seals require additional installation space and thus increase the axial height of the swing clamp.

Furthermore, a transmission gear for a parking brake of a motor vehicle is known from DE 10 2012 012 423 A1. However, this known transmission gear is not suitable for a swing clamp or a hydraulic swing motor.

Furthermore, the general technical background of the invention also includes the publications DE 10 2012 000 392 A1, DE 10 2017 221 512 A1, DE 27 57 507 A1 and DE 41 14 295 A1.

The invention is therefore based on the task of creating a possibility of reducing the axial overall height of a swing clamp.

This task is solved by a transmission gear according to the invention and the main claim.

The transmission gear according to the invention is generally used for converting movement from a driving movement to an output movement. The invention is therefore not limited to the use of the transmission gear according to the invention in a swing clamp. Rather, the transmission gear according to the invention can also be used in other ways.

In accordance with the prior art, the transmission gear according to the invention has a movable drive member which executes the driving movement during operation. In the preferred embodiment of a swing clamp, the drive member is preferably a piston which is axially displaceable under pressure medium actuation, the piston being driven, for example, pneumatically or hydraulically.

Furthermore, in accordance with the prior art, the transmission gear according to the invention has a movable output member which performs the output movement during operation. In the preferred embodiment of a swing clamp, it is preferably a rod that supports the clamp bar, the rod being both axially displaceable and swiveling.

Furthermore, as in the prior art, the transmission gear according to the invention also has a cam gear which converts the driving movement of the drive member (e.g. piston) into the output movement of the output member (e.g. rod) in accordance with a predetermined transmission curve.

It should be mentioned here that of the driving movement and the output movement, one of these movements is an axial movement along a predetermined axis of movement or contains at least one translational movement component along the axis of movement, while the respective other movement is a rotational movement about the axis of movement or contains at least one rotational movement component. In the preferred embodiment of the swing clamp, the driving movement is a pure axial movement without a rotational movement component, while the output movement is a combined rotational and axial movement.

The invention is now distinguished by the fact that the cam gear does not have a slotted guide system, as is the case with EP 1 264 659 B1. Instead, in the transmission gear according to the invention, the cam gear has two contact surfaces that slide on each other over an area and thus effect the conversion of movement. The contact surfaces sliding on each other are therefore preferably free-form surfaces, which preferably run along a helix. It should be mentioned here that the free-form surfaces are preferably non-circular in a cross-section perpendicular to the axis of movement. For example, the contact surfaces can be elliptical in a cross-section perpendicular to the axis of movement. An axial displacement of the contact surfaces sliding on each other relative to each other along the axis of movement thus inevitably leads to a rotational movement of the two contact surfaces relative to each other. Conversely, a rotation of the two contact surfaces relative to each other inevitably also leads to an axial movement of the contact surfaces relative to each other. Suitable shaping of the free-form surfaces allows virtually any transmission curves to be realized, with the transmission curves reflecting the relationship between the driving movement and the output movement.

It should also be mentioned that the cam gear is not self-locking. This is important so that a displacement or rotation of the contact surfaces relative to each other does not lead to a blocking of the cam gear. The contact surfaces are therefore preferably smooth, offset-free and positively or negatively curved.

It was mentioned above with respect to the prior art as a disadvantage that the seals increase the axial overall height of the swing clamp, which is undesirable. In the design according to the invention, however, a seal can be integrated into the contact surfaces. It should be mentioned here that the seal can be arranged in the axial direction in the area of the contact surfaces sliding on each other, so that no additional axial installation space is required to accommodate the seal.

For example, an annular groove can be arranged in one of the contact surfaces sliding on each other, which serves to accommodate the seal. The annular groove can optionally be arranged in the drive-side contact surface or in the output-side contact surface.

Furthermore, it should be mentioned that the two contact surfaces sliding on each other are preferably arranged on the drive member on the one hand and on the output member on the other hand. Alternatively, however, it is also possible for only the drive member or the output member to have a contact surface, while the corresponding further contact surface is arranged in a fixed position.

When the transmission gear according to the invention is used in a swing clamp, the driving movement of the drive member (e.g. piston) is preferably a pure axial movement without a rotational movement component. The drive member can therefore also be secured against rotation about the axis of movement. In the case of a piston as the drive member, this can be realized, for example, by the piston having an elliptical cross-section and being displaceable in a working cylinder with a correspondingly adapted elliptical cross-section.

The output movement of the output member, on the other hand, is preferably a pure rotational movement without a translational component in an initial phase of the output movement, as is known from swing clamps per se. Thus, in the initial phase, the axial driving movement of the piston leads only to a pivoting of the swing member without an axial movement.

In a final phase of the output movement, on the other hand, the output movement of the output member (e.g. swing bar) is preferably a pure axial movement without a rotational component. After the swing bar has been swiveled into the clamping position, the swing bar is then only moved axially in order to clamp a component.

In contrast, in a transition phase between the initial phase and the final phase, the output movement of the output member (e.g. swing bar) can be a combined rotational and axial movement.

Furthermore, it should be mentioned that the transmission gear may comprise an axial lock, which prevents an axial movement of the output member (e.g. swing bar) along the movement axis in the initial phase of the movement and releases the axial movement of the output member in the final phase. For this purpose, for example, the axial lock can have an elliptical disc that is torsionally rigidly connected to the output member or integrally formed on the output member. The elliptical disc can then only be axially displaced in a specific rotational position in an elliptical bore, whereas the elliptical disc otherwise blocks axial displacement.

It has already been briefly mentioned above that the drive member may be a piston displaceable in a working cylinder along the axis of movement, the piston being displaceable in the working cylinder by a working fluid actuated by pressure medium, for example hydraulically or pneumatically. The output member, on the other hand, can be a rod, as is known per se from swing clamps. In this case, the working cylinder and the piston may have a cross-section that is not circular, which prevents rotation of the piston in the working cylinder. For example, the piston and the working cylinder can have a non-cylindrical cross-section (e.g. a polygon or an ellipse). The shape of the piston and working cylinder should prevent rotation and can be made using a non-circular cross-section (for example, elliptical or polygonal).

In the preferred embodiment of the invention, the piston has a through axial bore, with a rod passing through the axial bore in the piston. The outer surface of the rod on the one hand and the inner surface of the axial bore in the piston on the other hand form the sliding contact surfaces for the movement conversion.

In general, it should be mentioned that the drive member is preferably mounted in a torsion-proof manner so that the drive member cannot rotate about the axis of movement. In contrast, the drive member is preferably axially displaceably mounted so that the drive member can move axially along the axis of movement.

In general, it should also be mentioned that the drive member preferably surrounds the output member in an annular manner. Alternatively, however, it is also possible for the output member to surround the drive member in an annular manner.

The above description parts preferably refer to the use of the transmission according to the invention in a swing clamp. However, it has already been mentioned above that other areas of application for the transmission according to the invention are also conceivable. The transmission gear according to the invention is therefore suitable for various movement conversions, which are described briefly below.

In one variant of the invention - see also FIG. 9 - the driving movement of the drive member is a pure axial movement without a rotational movement component, while the output movement of the output member is a pure rotational movement without a translational movement component. Here, the drive member is preferably secured against rotation about the axis of movement, so that the drive member cannot perform a rotational movement, but only an axial movement along the axis of movement. The output member, on the other hand, is preferably secured against displacement along the axis of movement in this variant of the invention, so that the output member cannot execute any axial movement along the axis of movement, but only a rotational movement about the axis of movement. The drive member is preferably a rod that is surrounded by a piston as the output member. The contact surfaces for the movement conversion are preferably located in the outer surface of the rod on the one hand and in the through bore of the piston on the other hand.

In another invention variant - see also FIG. 10 - the driving movement of the drive member is also a pure axial movement without a rotational movement component, while the output movement of the output member is a pure rotational movement without a translational movement component. This invention variant thus corresponds in part to the first invention variant described above. However, here the piston and rod are interchanged, i.e. the driving member is a piston, while the driven member is a rod.

In another invention variant - see also FIG. 11 - the driving movement of the drive member is a pure rotational movement without a translational movement component, while the output movement of the output member is a pure axial movement without a rotational movement component. The drive member is preferably secured against displacement along the axis of movement, so that the drive member cannot perform any axial movement, but only a rotational movement about the axis of movement. The output member, on the other hand, is secured against rotation about the axis of movement, so that the output member cannot perform any rotational movement, but only an axial movement along the axis of movement. Here, the driving member is a rod, while the driven member is a piston.

In a further variant of the invention - see also FIG. 12 - a pure rotational movement is also converted into a pure axial movement, as described above. However, here the driving member is a piston, while the driven member is a rod.

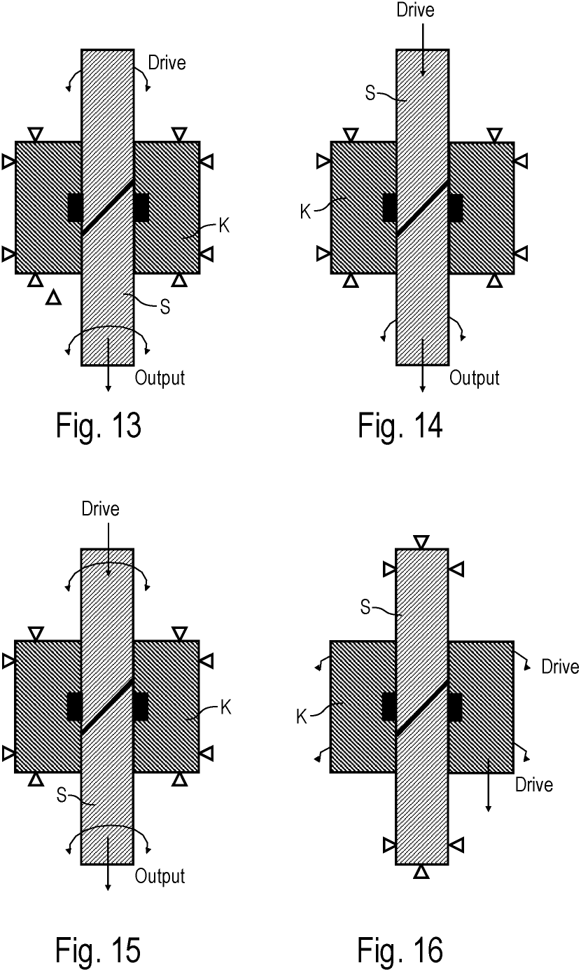

A further variant of the invention - see also FIG. 13 - provides that the driving movement of the drive member is a pure rotational movement without a translational movement component, while the output movement of the output member is a combined axial and rotational movement. Here, drive member and output member are identical and are formed by a rod surrounded by a piston. A rotation of the rod thus leads to a combination of a rotation and axial displacement of the rod. In this variant of the invention, the piston is therefore secured against both rotation and displacement and is thus stationary within the transmission gear.

Another variant of the invention - see also FIG. 14 - provides for a pure axial movement without a rotational movement component to be converted into a combined axial and rotational movement. Here, too, the drive member and output member are identical and are formed by a rod surrounded by a piston. The piston is also fixed within the transmission gear and is thus secured against both displacement and rotation.

Another variant of the invention - see also FIG. 15 - provides for a combined axial and rotational movement to be converted into a combined axial and rotational movement. Here, too, the drive member and the output member are identical and are formed by a rod surrounded by a piston, the piston again being arranged stationary within the transmission gear, i.e. the piston is secured against axial displacement and against rotation.

In a further variant of the invention - see also FIG. 16 - the driving movement of the drive member is a pure rotational movement, while the output movement of the output member is a combined axial and rotational movement. Here, too, the drive member and the output member are identical and are formed by a piston surrounding a rod. In this case, the rod is arranged stationary in the transmission gear, i.e. the rod is secured against axial displacement and against rotation.

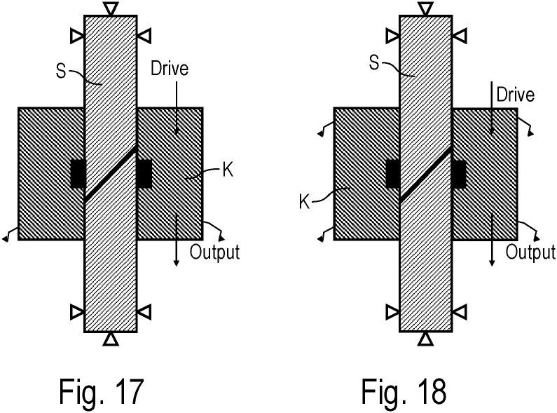

A further variant of the invention - see also FIG. 17 - provides for a pure axial movement on the input side, while a combined axial and rotational movement is generated on the output side. Here, too, drive member and output member are identical and are formed by a piston surrounding a rod, the rod being secured against both axial displacement and rotation.

In yet another embodiment - see also FIG. 18 - combined axial and rotational movements are present both on the input side and on the output side. Here, the drive member and output member are again identical and are formed by a piston surrounding a rod, the rod being secured against displacement and against rotation.

In the above-mentioned different variants of the invention, the contact surfaces (free-form surfaces) of the cam gear are located, on the one hand, in the outer circumferential surface of the rod and, on the other hand, in the inner surface of the piston.

The above description refers generally to a transmission according to the invention, irrespective of the field of application. However, the invention also claims protection for a swing clamp with such a transmission gear, wherein the clamping bar of the swing clamp is moved by the output member of the transmission gear, while the drive member is a piston which is displaceable in a working cylinder actuated by pressure medium. Furthermore, the invention also claims protection for a hydraulic swing motor with the transmission gear according to the invention. Thus, the transmission gear according to the invention is generally suitable for use in a swing device (e.g., swing motor, swing clamp).

Other advantageous further embodiments of the invention are indicated in the dependent claims or are explained in more detail below together with the description of the preferred embodiments of the invention with reference to the figures.

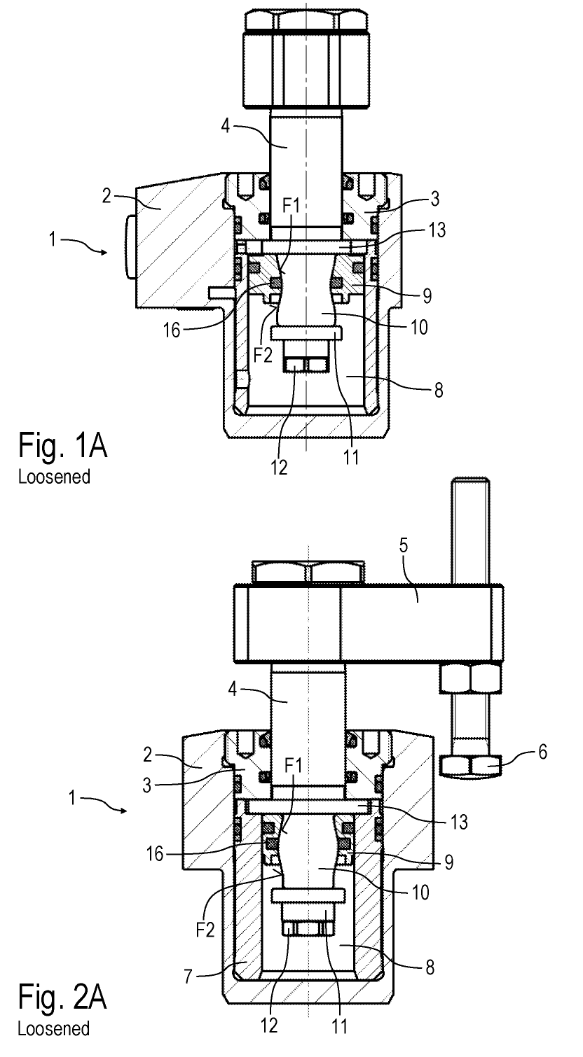

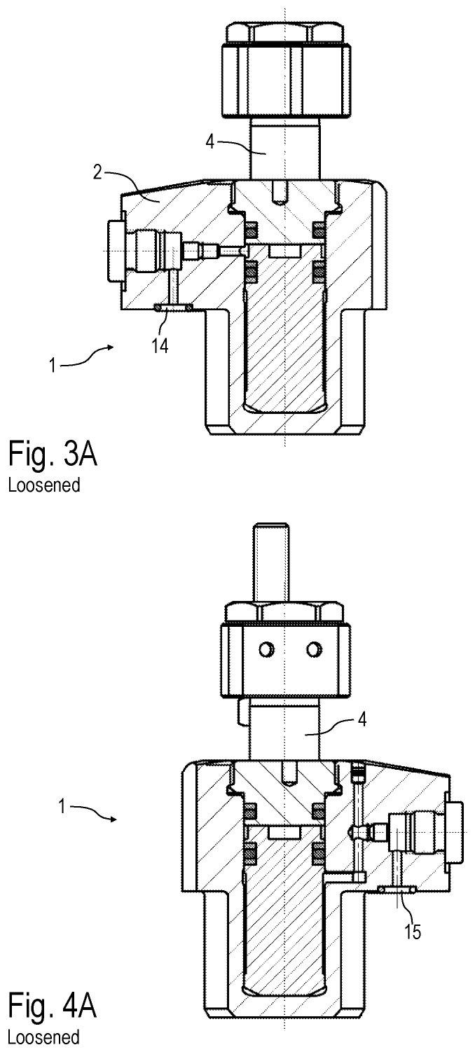

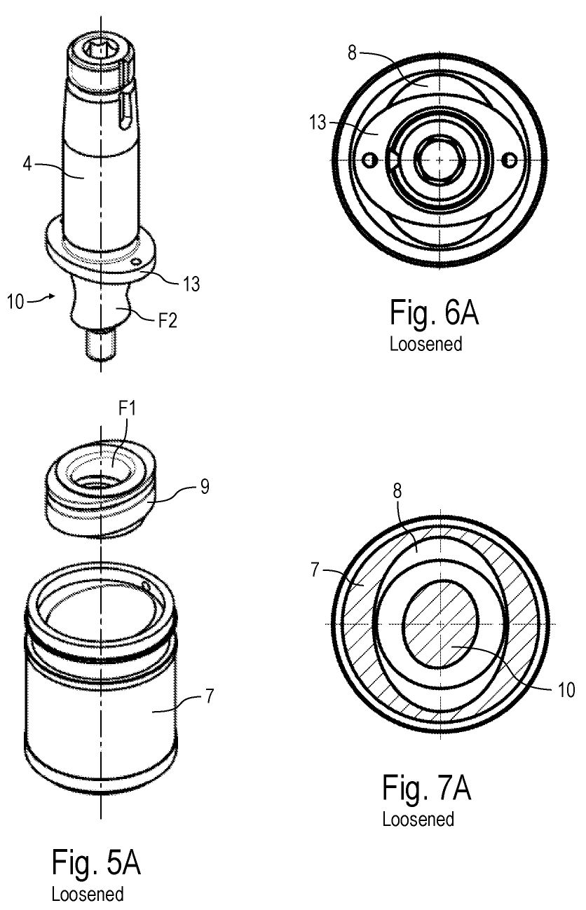

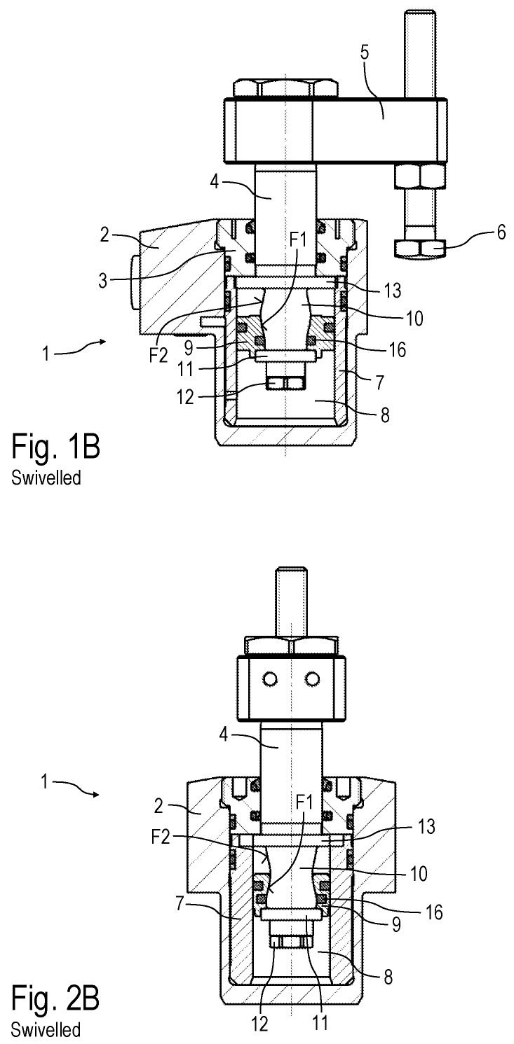

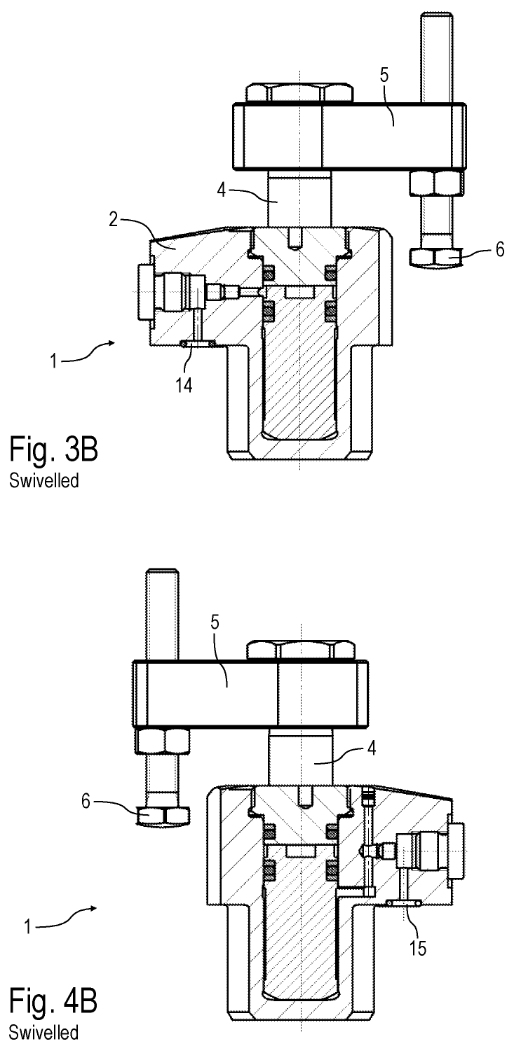

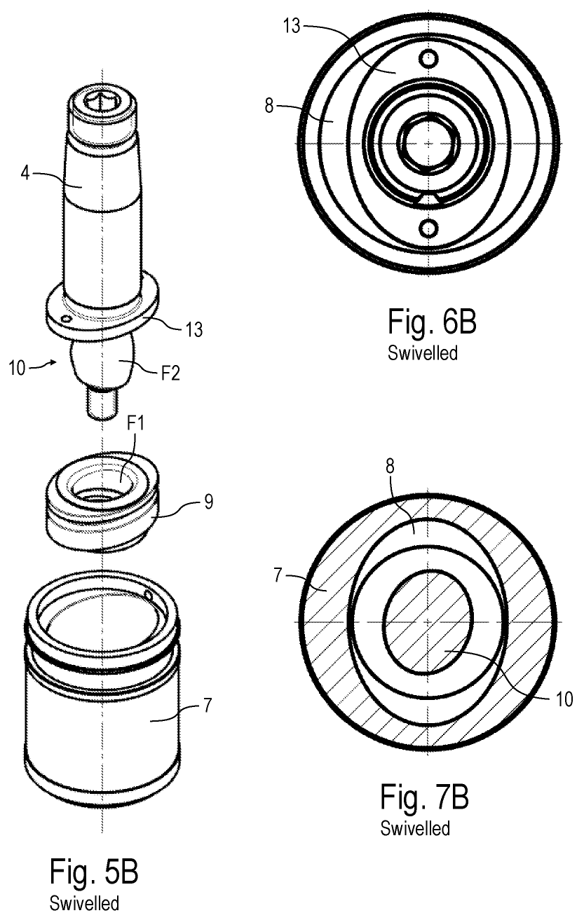

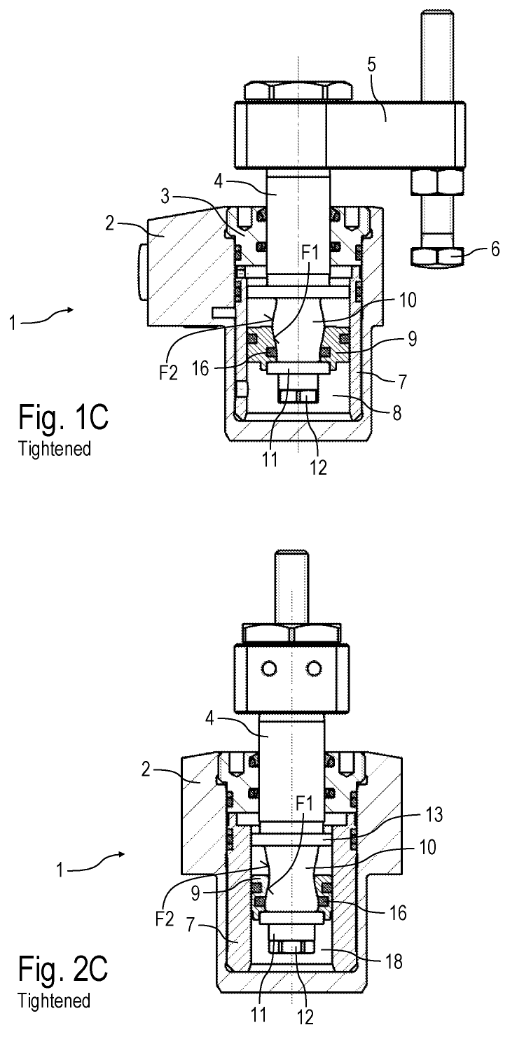

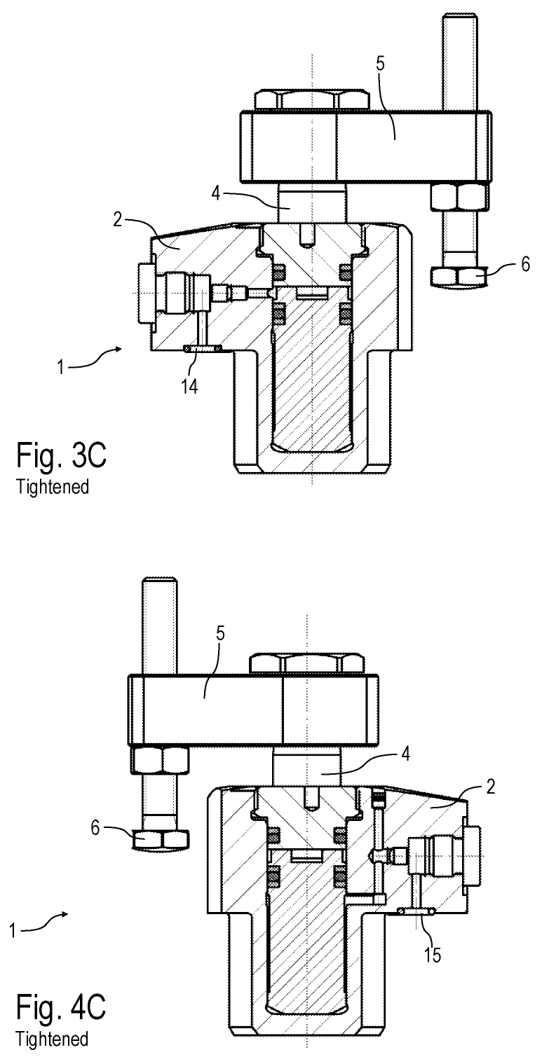

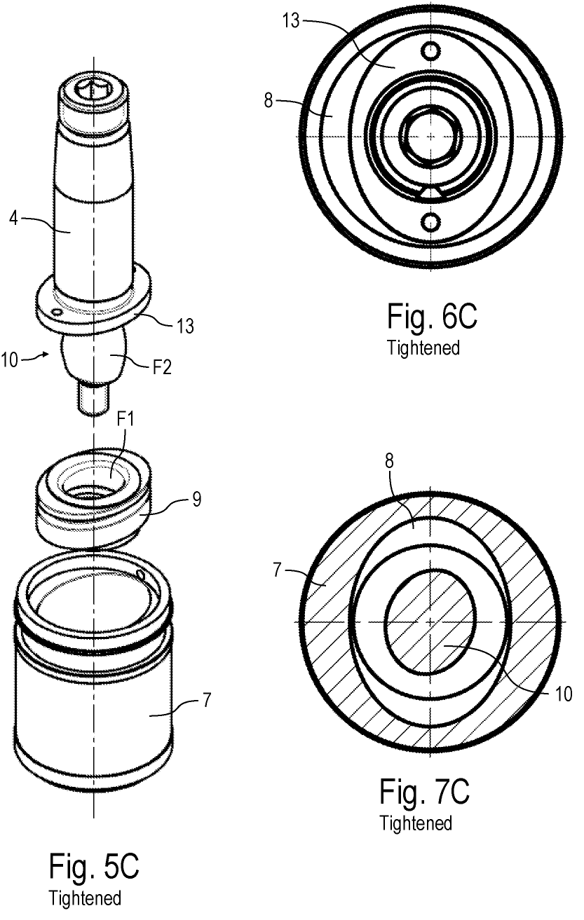

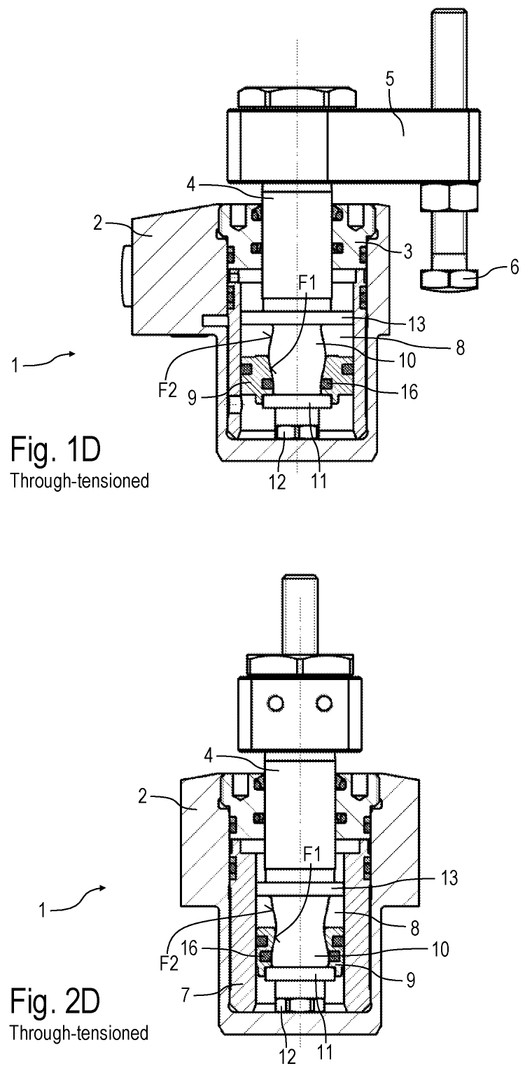

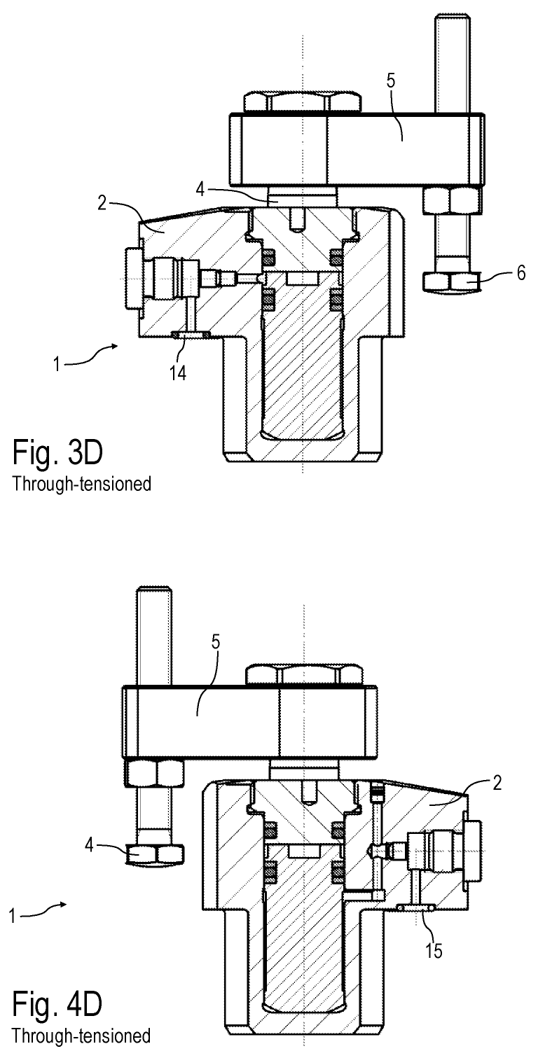

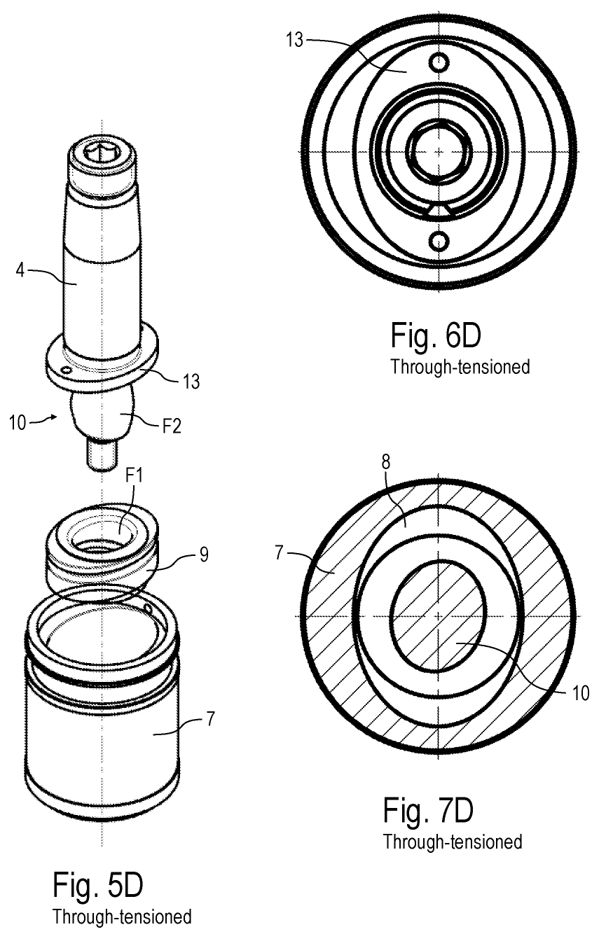

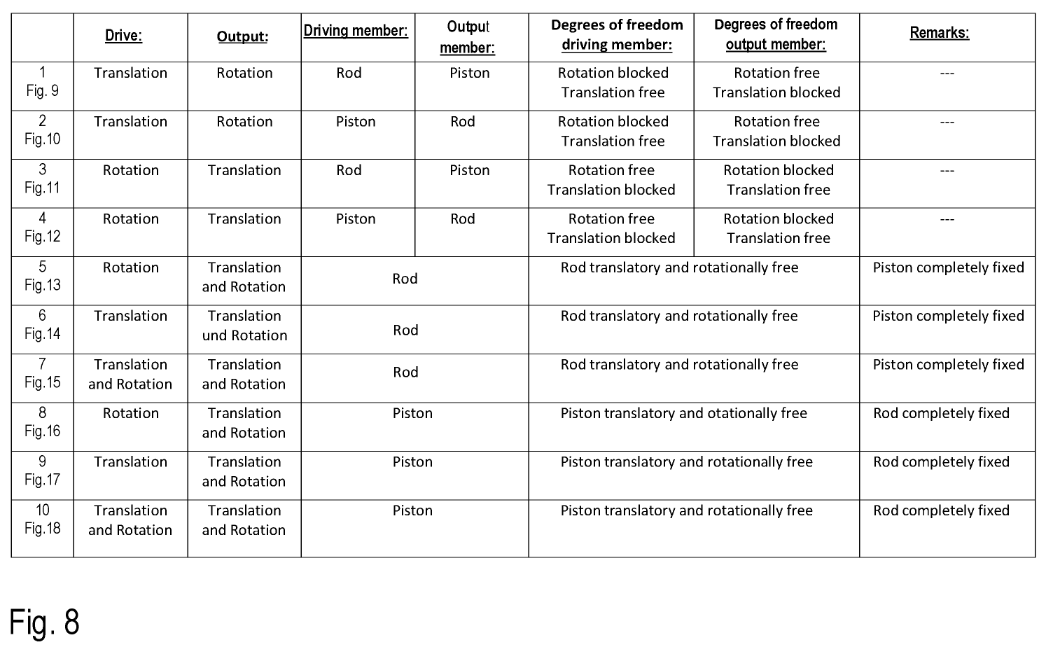

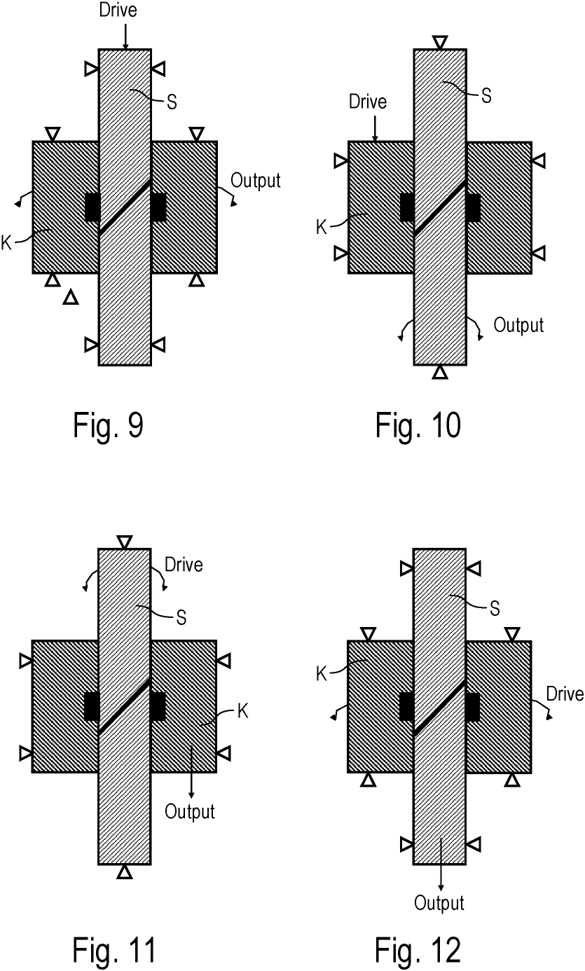

FIGS. 1A-7A show various views of a swing clamp according to the invention in a relaxed position.

FIGS. 1B-17B show the corresponding views in a pivoted position of the swing clamp.

FIGS. 1C-7C show the corresponding views of the swing clamp in a tensioned position.

FIGS. 1D-7D show the corresponding views of the swing clamp in a cocked position.

FIG. 8 shows a table listing the various possible movement conversions.

FIGS. 9-18 show schematic diagrams illustrating the various possible movement conversions from the table in FIG. 8.

In the following, the preferred embodiment of a swing clamp 1 according to the invention is described, as shown in FIGS. 1A-7A, 1B-7B, 1C-7C and 1D-7D. With regard to the basic design and operation of the swing clamp 1, reference is made to the relevant prior art, as known for example from EP 1 264 659 B1 and from DE 102 52 549 A1, in order to avoid repetition. In the following, therefore, only some details of the swing clamp 1 essential to the invention will be described.

Thus, the swing clamp 1 firstly has a housing 2 which is closed off by a housing cover 3 on its upper side.

A swing piston 4 extends through a bore in the housing cover 3, which supports a swing arm 5 with a swing bar 6 mounted thereon. The swing piston 4 is vertically displaceable with the swing arm 5 and the clamping bar 6 and can be swiveled about a vertical swing axis, as is known per se from the prior art and will still be described in detail. At this point it is only to be mentioned that the swing piston 4 together with the clamping bar 6 and the swing arm 5 form an output member in the sense of the invention.

In the housing 2, an adjusting bush 7 is arranged at the bottom, which has an elliptical internal cross-section and forms a working cylinder 8 with an elliptical cross-section.

A piston 9 is axially displaceable in the working cylinder 8, the piston 9 also having an elliptical cross-section. The piston 9 can thus be axially displaced in the working cylinder 8, i.e. in the vertical direction, whereas rotation of the piston 9 in the working cylinder 8 is not possible. The piston here forms a drive member in the sense of the invention.

The piston 9 has a central bore through which an elliptical body 10 is passed, which is integrally formed at the lower end of the swing piston 4, the elliptical body 10 having on its outer lateral surface a curved free-form surface F2 which follows a helical line. The through-bore in the piston 9 has a correspondingly adapted curved free-form surface F1 on the inside, which also follows a helix. An axial displacement of the piston 9 relative to the elliptical body 10 thus leads to a conversion of movement corresponding to a largely freely predeterminable transmission curve.

It should also be mentioned that a stop 11 and a lock nut 12 are screwed tightly to the lower end of the swing piston 4.

An elliptical disc 13 is formed on the swing piston 4 to form an axial lock. Thus, in the relaxed swing position according to FIGS. 1A-7A, the elliptical disc 13 rests on the upper side of the adjusting bush 7, so that the swing piston 4 with the elliptical disc 13 cannot be moved axially downwards.

Furthermore, it should be mentioned that the piston 9 in the working cylinder 8 can be displaced in axial direction by pressure medium. For this purpose, the swing clamp 1 has hydraulic connections 14, 15.

In the following, the transition from the relaxed position according to FIGS. 1A-7A to the swing position according to FIGS. 1B-7B is described.

Here, the piston 9 is moved axially downward in the working cylinder 8, whereby the piston 9 is secured against rotation due to the elliptical cross-sections of the working cylinder 8 and the piston 9.

During this downward movement of the piston 9, the free-form surfaces F1, F2 in the outer lateral surface of the elliptical body 10 on the one hand and in the through bore of the piston 9 on the other hand slide on each other, resulting in a conversion of movement. The pure axial movement of the piston 9 is initially converted into a pure rotary movement of the swing piston 4.

In this case, the elliptical disc 13 of the swing piston 4 rests on the upper side of the adjusting bushing 7 and thus prevents axial displacement of the swing piston 4.

In the swing position according to FIGS. 1B-7B, on the other hand, the elliptical disc 13 on the swing piston 4 is rotated so that it is in position with the working cylinder 8. As a result, the elliptical disc 13 can then dip downward into the working cylinder 8, which also allows a corresponding axial movement of the swing piston 4. During a further downward movement of the piston 9, the latter then takes the swing piston 4 along axially and then reaches the tensioned position according to FIGS. 1C-7C and finally the fully tensioned position according to FIGS. 1D-7D.

Furthermore, it should be mentioned that an annular groove is let into the free-form surface F1 in the through-bore of the piston 9, in which a seal 16 is arranged. The seal 16 here prevents axial media passage through the gap between the free-form surfaces F1, F2 which slide on one another. It is advantageous here that the seal 16 can be arranged directly in the free-form surface F1, so that no additional axial installation space is required.

FIG. 8 shows a table with various possible configurations for the conversion of movement from the drive member to the output member, irrespective of the specific area of application in the swing clamp 1.

FIGS. 9-18 show simple, schematic representations of the gear construction for the conversion of movement between a rod S and a piston K, where the rod S has a free-form surface in its outer surface which interacts with a corresponding free-form surface in the through-bore of the piston K. The two corresponding free-form surfaces here run along a helical line, as shown only schematically.

From the illustrations and from the table according to FIG. 8, it is immediately apparent that different configurations are possible, in which in part the rod S forms the drive member, while the piston K is an output member. In other configurations, however, the piston K is the driving member, while the rod S is the driven member. Otherwise, the operation of the configurations shown is explained in the table according to FIG. 8.

The invention is not limited to the preferred embodiments described above. Rather, a large number of variants and variations are possible which also make use of the inventive concept and therefore fall within the scope of protection. In particular, the invention also claims protection for the subject matter and the features of the dependent claims independently of the claims referred to in each case and in particular also without the features of the main claim. The invention thus comprises different aspects of the invention which enjoy protection independently of each other.

List of reference signs

| | |
|---|---|
| 1 | Swing clamp |
| 2 | Housing of the swing clamp |
| 3 | Housing cover |
| 4 | Swing piston |
| 5 | Swing arm |
| 6 | Clamping bar |
| 7 | Adjusting bush with elliptical internal cross-section |
| 8 | Working cylinder with elliptical cross section |
| 9 | Piston with elliptical outer cross section and inner free-form surface |
| 10 | Elliptical body on swing piston with free-form surface |
| 11 | Stop |
| 12 | Lock nut |
| 13 | Elliptical disc on the swing piston |
| 14, 15 | Hydraulic connections of the swing clamp |
| 16 | Seal |
| F1 | Free-form surface in the piston 9 |
| F2 | Free-form surface on the elliptical body 10 |
| S | Rod with outer free-form surface |
| K | Piston with inner free-form surface |

1-15. (canceled)

16. A transmission gear for converting movement from a driving movement into an output movement, comprising:
a) a movable drive member which in operation executes the driving movement,
b) a movable output member which in operation executes the output movement, and
c) a cam gear which converts the driving movement of the drive member into the output movement of the output member in accordance with a predetermined transmission curve,
d) wherein of the driving movement and the output movement one movement comprises an axial movement along a predetermined axis of movement, while the other movement comprises a rotational movement about the axis of movement,
e) wherein the cam gear has two contact surfaces which slide on one another in an areal manner and thereby effect conversion of movement.

17. The transmission gear according to claim 16, wherein the drive member is a piston and the output member is a rod.

18. The transmission gear according to claim 16, wherein the contact surfaces which slide on one another are free-form surfaces.

19. The transmission gear according to claim 18, wherein the free-form surfaces run along a helix.

20. The transmission gear according to claim 18, wherein the free-form surfaces are non-circular in a cross-section at right angles to the axis of movement.

21. The transmission gear according to claim 16, wherein the cam gear is not self-locking.

22. The transmission gear according to claim 16, wherein
a) a seal is provided in order to prevent a flow of a medium along the axis of movement at the contact surfaces which slide on one another, and
b) the seal is arranged in an axial direction in a region of the contact surfaces sliding on one another.

23. The transmission gear according to claim 22, wherein an annular groove is let into one of the contact surfaces sliding on one another axially in the region of the contact surfaces sliding on one another, the seal being arranged in the annular groove.

24. The transmission gear according to claim 16, wherein one of the two contact surfaces is arranged on the drive member, while the other of the two contact surfaces is arranged on the output member.

25. The transmission gear according to claim 16, wherein
a) the driving movement of the drive member in an initial phase is a pure axial movement without a rotational movement component,
b) the output movement of the output member in the initial phase is a pure rotational movement without a translational component, and
c) the output movement of the output member in a final phase is a pure axial movement without a rotational component.

26. The transmission gear according to claim 25, wherein the output movement of the output member in a transition phase between the initial phase and the final phase is a combined rotational and axial movement.

27. The transmission gear according to claim 26, wherein an axial lock is provided which prevents an axial movement of the output member along the axis of movement in the initial phase of the movement and releases the axial movement of the output member in the final phase.

28. The transmission gear according to claim 27, wherein
a) the axial lock has a disc which is connected to the output member in a rotationally rigid manner,
b) the disc is axially displaceable in a bore and only in a certain rotational position of the output member with the disc, whereas the disc otherwise blocks the axial movement of the output member, and
c) the disc is secured against rotation in the bore.

29. The transmission gear according to claim 28, wherein the disc and the bore have an elliptical cross-section in order to effect rotational locking.

30. The transmission gear according to claim 16, wherein
a) the drive member is a piston or is driven by a piston,
b) the piston is displaceable in a working cylinder along the axis of movement,
c) the piston is displaceable in the working cylinder by a working fluid actuated by a pressure medium, and
d) the output member is a rod.

31. The transmission gear according to claim 30, wherein the working cylinder and the piston have a cross-section which is not circular, so that the piston in the working cylinder cannot be rotated about the axis of movement, but can only be displaced along the axis of movement.

32. The transmission gear according to claim 31, wherein
a) the piston has a through axial bore,
b) the rod is guided through the axial bore in the piston, and
c) the outer circumferential surface of the rod and the inner surface of the axial bore in the piston are the contact surfaces which slide on one another.

33. The transmission gear according to claim 16, wherein
a) the drive member is mounted in a torsion-proof manner so that the drive member cannot rotate about the axis of movement, and
b) the drive member is mounted so as to be axially displaceable, so that the drive member can move axially along the axis of movement.

34. The transmission gear according to claim 16, wherein the drive member annularly surrounds the output member.

35. The transmission gear according to claim 16, wherein the output member annularly surrounds the drive member.

36. The transmission gear according to claim 16, wherein
a) the driving movement of the drive member is a pure axial movement without a rotational movement component, while the output movement of the output member is a pure rotational movement without a translational movement component,
b) the drive member is secured against rotation about the axis of movement, so that the drive member cannot perform a rotational movement, and
c) the output member is secured against displacement along the axis of movement, so that the output member cannot perform an axial movement.

37. The transmission gear according to claim 36, wherein the drive member is a rod, while the output member is a piston.

38. The transmission gear according to claim 36, wherein the drive member is a piston, while the output member is a rod.

39. The transmission gear according to claim 16, wherein
a) the driving movement of the drive member is a pure rotational movement without a translational movement component, while the output movement of the output member is a pure axial movement without a rotational movement component,
b) the drive member is secured against displacement along the axis of movement, so that the drive member cannot perform an axial movement, and
c) the output member is secured against rotation about the axis of movement, so that the output member cannot perform a rotational movement.

40. The transmission gear according to claim 39, wherein the drive member is a rod, while the output member is a piston.

41. The transmission gear according to claim 39, wherein the drive member is a piston, while the output member is a rod.

42. The transmission gear according to claim 16, wherein
a) the driving movement of the drive member is a pure rotational movement without a translational movement component, while the output movement of the output member is a combined axial and rotational movement,
b) the drive member also constitutes the output member, and
c) the drive member and the output member area rod, which is surrounded by a piston.

43. The transmission gear according to claim 42, wherein the piston is secured against displacement and against rotation.

44. The transmission gear according to claim 16, wherein
a) the driving movement of the drive member is a pure axial movement without a rotational movement component, while the output movement of the output member is a combined axial and rotational movement,
b) the drive member also forms the output member,
c) the drive member and the output member area rod, which is surrounded by a piston, and
d) the piston is secured against displacement and against rotation.

45. The transmission gear according to claim 16, wherein
a) the driving movement of the drive member is a combined axial and rotational movement, while the output movement of the output member is a combined axial and rotational movement,
b) the drive member also forms the output member,
c) the drive member and the output member area rod surrounded by a piston, and
d) the piston is secured against displacement and against rotation.

46. The transmission gear according to claim 16, wherein
a) the driving movement of the drive member is a pure rotational movement, while the output movement of the output member is a combined axial and rotational movement,
b) the drive member also constitutes the output member,
c) the drive member and the output member area piston surrounding a rod, and
d) the rod is secured against displacement and against rotation.

47. The transmission gear according to claim 16, wherein
a) the driving movement of the drive member is a pure axial movement, while the output movement of the output member is a combined axial and rotational movement,
b) the drive member also forms the output member,
c) the drive member and the output member area piston, which surrounds a rod, and
d) the rod is secured against displacement and against rotation.

48. The transmission gear according to claim 16, wherein
a) the driving movement of the drive member is a combined axial and rotational movement, while the output movement of the output member is a combined axial and rotational movement,
b) the drive member also forms the output member,
c) the drive member and the output member are a piston which surrounds a rod, and
d) the rod is secured against displacement and against rotation.

49. The transmission gear according to claim 17, wherein the contact surfaces of the cam gear are arranged on the one hand in an outer lateral surface of the rod and on the other hand in an inner surface of the piston.

50. A swing device with a transmission gear according to claim 16 for moving a clamping bar during a clamping process.

51. The swing device according to claim 50, wherein the swing device is a swing clamp for clamping components.

52. The swing device according to claim 51, wherein
a) the clamping bar is moved by the output member of the transmission gear, and
b) the drive member is a piston which is displaceable in a working cylinder under pressure medium actuation.
